(19) United States
(12) Patent Application Publication
(10) Pub. No.: US 2010/0317912 A1
(43) Pub. Date: Dec. 16, 2010

(54) MAT FOR ABSORBING LIQUIDS

(76) Inventor: Anthony J. Senzamici, JR., Lakeland, FL (US)

Correspondence Address: LARSON AND LARSON, 11199 69TH STREET NORTH, LARGO, FL, 33773, US

(21) Appl. No.: 12/484,688

(22) Filed: Jun. 15, 2009

(51) Int. Cl. A62D 3/00; B01J 20/26; A62D 5/00

(52) U.S. Cl. 588/249.5; 502/402

(57) ABSTRACT

A fluid absorption mat is applied to a surgery/operating room floor during a medical procedure. The fluids are absorbed through an upper and lower non-woven, non-cellulose fibrous layer. The upper and lower layers dry while an intermediate layer made of a cloth or paper integrated with copolymers absorbs and retains fluids introduced into the absorption mat. Medical personnel are thereby exposed to minimal fluids and surgery room cleanup is more efficient.

### FIELD OF THE INVENTION

This invention relates to the medical field and more particularly to a mat for absorbing liquids.

### BACKGROUND

Liquid absorptive polymer materials are well known in the prior art as seen in U.S. Pat. Nos. 4,295,987 and 4,865,886. In addition, it is known to incorporate these polymers between paper or diaper cloth to make absorptive materials. The aforementioned U.S. Pat. No. 4,865,886 describes polymerizing acrylic acid monomers on prefabricated fibrous substrate to form a composite of the polymer derived from the monomer and said fibrous substrate. Cross linking agents are then reacted with the polymer to form a liquid absorptive polymer.

The prior art composite materials are excellent vehicles for absorbing liquids, but are not designed to retain liquids when pressure, such as the weight of a person, is exerted on the absorbent materials.

U.S. Pat. No. 5,434,339 to La Motte, et al, describes a fluid absorption mat that has copolymer interlocked between two layers of an absorbent, non-woven fiber. This patent is hereby incorporated by reference. The fluid absorption mat described in this patent has a different intermediate layer and the patent does not disclose a non-porous, skid-resistant backing.

A method for employing a self contained floor mat is needed which will absorb and retain fluids in the floor mat even when there is the pressure of a standing person and prevent leakage of the fluids during the disposal process.

### SUMMARY OF THE INVENTION

The present invention includes a fluid absorption mat for application to a surgery/operating room floor during a medical procedure. The fluids are absorbed through an upper and lower non-woven, non-cellulose fibrous layer. The upper and lower layers dry while an intermediate layer made of a cloth or paper integrated with copolymers absorbs and retains fluids introduced into the absorption mat. Medical personnel are thereby exposed to minimal fluids and surgery room cleanup is more efficient.

In one embodiment, an operating room absorption mat is disclosed including a top layer made of a fluid-absorbing, non-woven, non-cellulose, fibrous material, a bottom layer made of the fluid-absorbing, non-woven, non-cellulose, fibrous material and an intermediate layer made of a sheet of fluid absorbing material. An outer edge area of the top layer and an outer edge area of the bottom layer are bonded together, thereby retaining the intermediate layer.

In another embodiment, a method of protecting surgery room personnel is disclosed including applying to a surgery room floor in an area onto which fluids drip, an operating room absorption mat. The absorption mat includes a top layer made of a fluid-absorbing, non-woven, non-cellulose, fibrous material, a bottom layer made of the fluid-absorbing, non-woven, non-cellulose, fibrous material and an intermediate layer made of a sheet of fluid absorbing material. An outer edge area of the top layer and an outer edge area of the bottom layer are bonded together. When the procedure is complete, the operating room absorption mat is disposed of in a hazardous waste approved container.

In another embodiment, an operating room absorption mat is disclosed including a top layer and a bottom layer, both layers made of felt. An intermediate layer made of a sheet of fluid absorbing material is situated between the top layer and the bottom layer whereas an outer edge area of the top layer and an outer edge area of the bottom layer are bonded together, thereby retaining the intermediate layer.

### BRIEF DESCRIPTION OF THE DRAWINGS

The invention can be best understood by those having ordinary skill in the art by reference to the following detailed description when considered in conjunction with the accompanying drawings in which:

FIG. 1 depicts a method of the present invention.

FIG. 2 is a top perspective view of the mat of the present invention.

FIG. 3 is a top plan view of the mat of the present invention.

FIG. 4A is a sectional view along line 4-4 of the mat of the present invention.

FIG. 4B is a sectional view along line 4-4 of the mat of the present invention.

FIG. 4C is a sectional view along line 4-4 of the mat of the present invention.

FIG. 4D is a sectional view along line 4-4 of the mat of the present invention.

FIG. 5 is a perspective view of a method of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

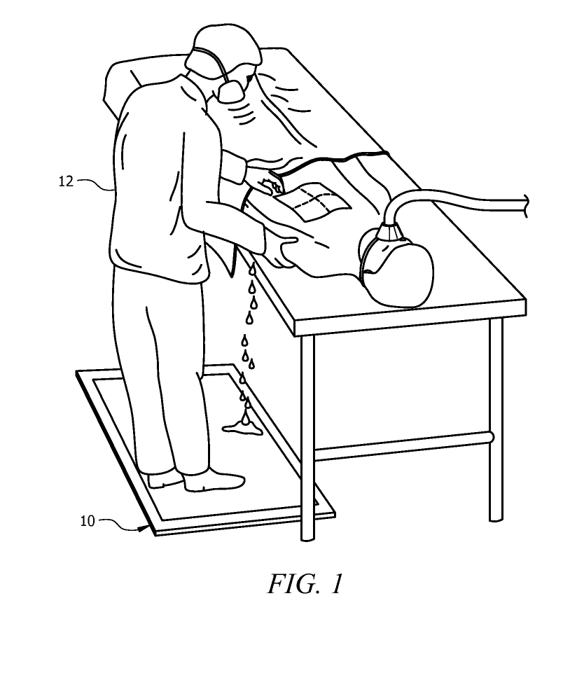

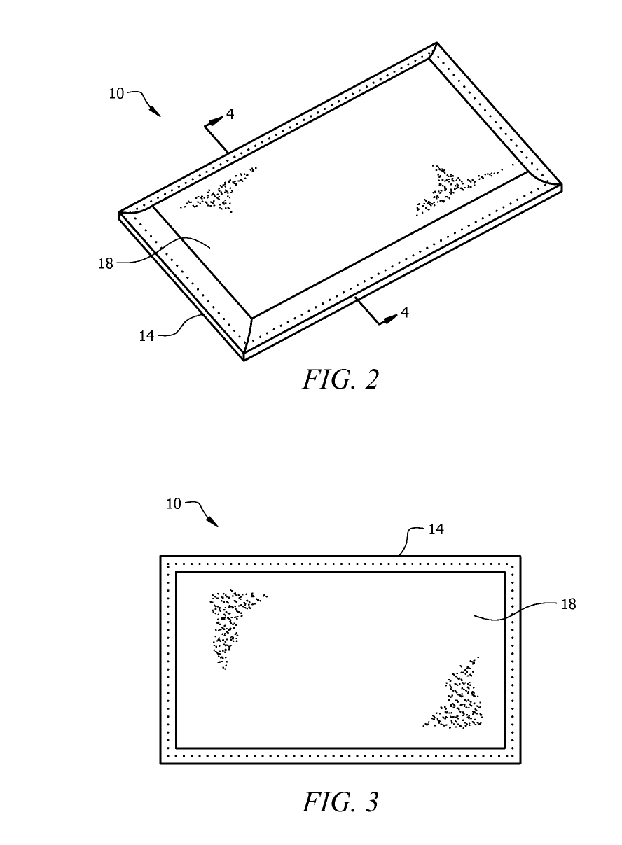

The method and apparatus of absorbing and retaining fluids during a medical procedure is shown in FIG. 1. A mat 10 is placed on a hospital room operating floor or ambulatory surgery center floor in an area where fluids drip and hospital personnel 12 stand during a medical procedure as shown in FIG. 1. The mat 10 has three layers, an upper layer 14, a bottom layer 16, and an intermediate layer 18, as shown in FIGS. 2, 3 and 4A-4D. The mat 10 captures and absorbs such liquids for proper disposal (see FIG. 5).

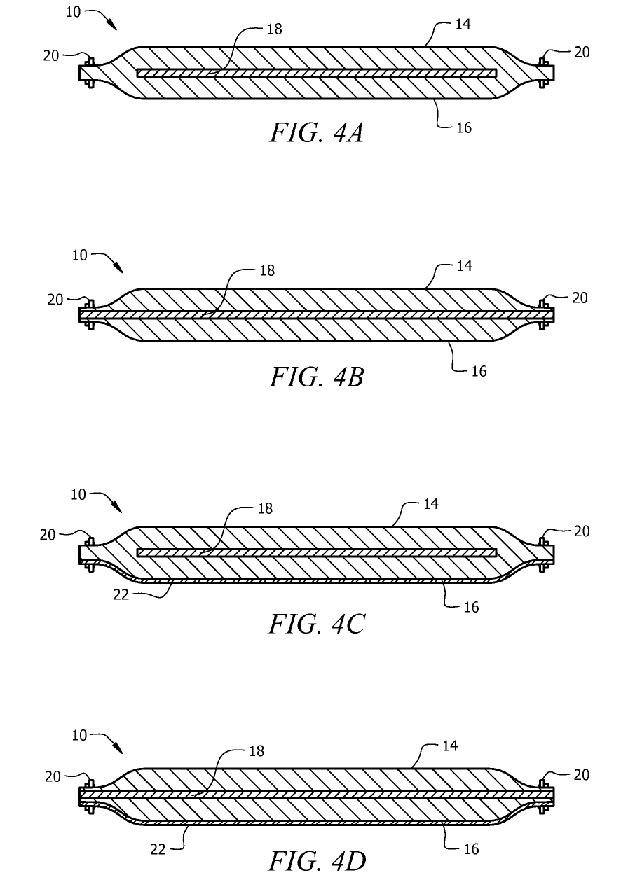

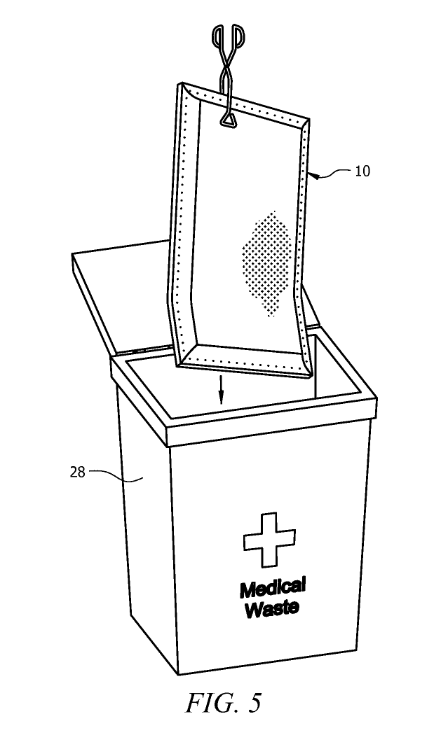

Referring to FIG. 2, a top perspective view of the mat of the present invention is shown. Although there are many ways known to assemble layers to a mat 10, the layers 14, 16 and 18 (see FIGS. 4A-D) are shown joined by needle punches or stitches. Other methods are anticipated such as the use of an adhesive, static force, melting, compression, etc, as known in the art.

Referring to FIG. 3, a top plan view of the mat of the present invention is shown. Again, in this example, the layers 14/16/18 are shown assembled using needle punches and/or stitches.

Referring to FIG. 4A, a sectional view of the mat of the present invention is shown. The upper layer 14 and the bottom layer 16 are made of a fluid absorbing, non-woven, non-cellulose, fibrous material such as felt. The intermediate layer 18 is a sheet of a porous material that includes polymers either internal to the structure of the porous material, external to the structure (adhered) of the porous material or both internal and external. The polymers are distributed (or impregnated) within (e.g. within the weave of the sheet of porous material) or on an outer surface of the sheet of porous material such that the sheet of porous material provides a conduit or wick connecting the individual polymers, such that, fluids entering in one area of the mat 10 are absorbed by the polymers at that location and, excess fluids migrate though the sheet of porous material to nearby polymers. In some embodiments, the sheet of porous material is cloth or paper. In some embodiments, the sheet of porous material is air-laid cellulous. In some embodiments, the sheet of porous material is woven.

In some embodiments, the sheet of porous material has a single layer, while in other embodiments, the sheet of porous material has multiple layers (such as in the art of manufacturing paper towels) and, in such, the polymers are either distributed between the layers and/or adhered to one or both outside layers and/or impregnated into the fibers of the porous material.

The intermediate layer 18, being the sheet of porous material having polymers, provides several enhanced features to the mat 10. Being a sheet, the polymers remain evenly distributed across the mat 10, even during transportation and foot traffic. Since the sheet of porous material is cloth-like or paper-like, liquids are absorbed at the spill site and spread through capillary action throughout the intermediate layer 18 instead of remaining at the spill site. In this embodiment, the intermediate layer 18 is not anchored and does not pass between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18.

Referring to FIG. 4B, a sectional view of the mat of the present invention is shown. As in the example of FIG. 4A, the upper layer 14 and the bottom layer 16 are made of a fluid absorbing, non-woven, non-cellulose, fibrous material such as felt. As in FIG. 4A, the intermediate layer 18 is made of a sheet porous material integrated with polymers. The intermediate layer 18, being a sheet of porous material with polymers, provides several enhanced features of the mat 10. Being a sheet, it remains evenly distributed across the mat 10, even during transportation and foot traffic. Since the sheet of porous material is cloth-like or paper-like, liquids are absorbed at the spill site and spread through capillary action throughout the intermediate layer 18 instead of remaining at the spill site. In this embodiment, the intermediate layer 18 is anchored, passing between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18.

Referring to FIG. 4C, a sectional view of the mat of the present invention is shown. The upper layer 14 and the bottom layer 16 are made of a fluid absorbing, non-woven, non-cellulose, fibrous material such as felt. As in FIGS. 4A and 4B, the intermediate layer 18 is made of a sheet porous material integrated with polymers. The intermediate layer 18, being a sheet of porous material with polymers, provides several enhanced features of the mat 10. Being a sheet, it remains evenly distributed across the mat 10, even during transportation and foot traffic. Since the sheet of porous material is cloth-like or paper-like, liquids are absorbed at the spill site and spread through capillary action throughout the intermediate layer 18 instead of remaining at the spill site. In this embodiment, the intermediate layer 18 is not anchored and does not pass between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18. In this embodiment, a non-porous, high-friction layer 22 is applied to the outer surface of the bottom layer 16. For example, a hot liquid rubber is applied or painted on the outside surface of the bottom layer 16, forming a non-porous, non-skid backing to reduce seepage through the mat 10 and reduce the potential from the mat 10 slipping out from under the workers 12.

Referring to FIG. 4D, a sectional view of the mat of the present invention is shown. As in the example of FIG. 4C, the upper layer 14 and the bottom layer 16 are made of a fluid absorbing, non-woven, non-cellulose, fibrous material such as felt. As in FIGS. 4A, 4B and 4C, the intermediate layer 18 is made of a sheet porous material integrated with polymers. The intermediate layer 18, being a sheet of porous material with polymers, provides several enhanced features of the mat 10. Being a sheet, it remains evenly distributed across the mat 10, even during transportation and foot traffic. Since the sheet of porous material is cloth-like or paper-like, liquids are absorbed at the spill site and spread through capillary action throughout the intermediate layer 18 instead of remaining at the spill site. In this embodiment, the intermediate layer 18 is anchored, passing between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18.

In this embodiment, a non-porous, high-friction layer 22 is applied to the outer surface of the bottom layer 16. For example, a hot liquid rubber is applied or painted on the outside surface of the bottom layer 16, forming a non-porous, non-skid backing to reduce seepage through the mat 10 and reduce the potential from the mat 10 slipping out from under the workers 12.

Referring to FIG. 5, a perspective view of a method of the present invention is shown. After use, the mat 10 is disposed in a container 28 or any other disposal system. Because of the mat's 10 absorbency, little or no fluids migrate or drip from the mat 10 as shown in FIG. 5. It is anticipated that in some applications, the mat 10 retains several times its own weight in fluids.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. An operating room absorption mat, the absorption mat comprising:
a top layer made of a fluid-absorbing, non-woven, non-cellulose, fibrous material;
a bottom layer made of the fluid-absorbing, non-woven, non-cellulose, fibrous material; and
an intermediate layer made of a sheet of polymer;
wherein at least an outer edge area of the top layer and an outer edge area of the bottom layer is bonded together.

2. The absorption mat of claim 1, wherein at least the outer edge area of the top layer, the outer edge area of the bottom layer and an outer edge of the intermediate layer is bonded together.

3. (canceled)

4. (canceled)

5. The absorption mat of claim 1, wherein the fluid-absorbing, non-woven, non-cellulose, fibrous material is felt.

6. The absorption mat of claim 1, wherein the at least an outer edge area of the top layer and an outer edge area of the bottom layer is bonded together by a needle punch.

7. The absorption mat of claim 1, wherein the at least an outer edge area of the top layer and an outer edge area of the bottom layer is bonded together by an adhesive.

8. The absorption mat of claim 1, wherein the at least an outer edge area of the top layer and an outer edge area of the bottom layer is bonded together by stitching.

9. The absorption mat of claim 1, further comprising a non-porous, anti-slip coating on an outer side of the bottom layer.

10. A method of protecting surgery room personnel comprising:
applying an operating room absorption mat to a surgery room floor in an area onto which fluids drip, the absorption mat comprising:
a top layer made of a fluid-absorbing, non-woven, non-cellulose, fibrous material;
a bottom layer made of the fluid-absorbing, non-woven, non-cellulose, fibrous material;
an intermediate layer made of a sheet of polymer;
wherein at least an outer edge area of the top layer and an outer edge area of the bottom layer is bonded together
disposing of the operating room absorption mat in a hazardous waste approved container.

11. (canceled)

12. (canceled)

13. The method of claim 10, wherein the fluid-absorbing, non-woven, non-cellulose, fibrous material is felt.

14. The method of claim 10, wherein the at least an outer edge area of the top layer and an outer edge area of the bottom layer is bonded together by a needle punch.

15. The method of claim 10, wherein the at least an outer edge area of the top layer and an outer edge area of the bottom layer is bonded together by an adhesive.

16. The method of claim 10, wherein the at least an outer edge area of the top layer and an outer edge area of the bottom layer is bonded together by stitching.

17. An operating room absorption mat, the absorption mat comprising:
a top layer and a bottom layer, both layers made of felt; and
an intermediate layer made of a sheet of polymer;
wherein at least an outer edge area of the top layer and an outer edge area of the bottom layer is bonded together, thereby retaining the intermediate layer between the top layer and the bottom layer.

18. (canceled)

19. (canceled)

20. The absorption mat of claim 17, further comprising a non-porous, anti-slip coating on an outer side of the bottom layer.
